(19) United States
(12) Patent Application Publication
(10) Pub. No.: US 2006/0177613 A1
(43) Pub. Date: Aug. 10, 2006

(54) Method of forming film for the construction of bags for vacuum packaging of products

(76) Inventors: Riccardo Abate, S. Martino Della Battaglia (IT); Luigi Abate, S. Martino Della Battaglia (IT)

Correspondence Address: MCGLEW & TUTTLE, PC, P.O. BOX 9227, SCARBOROUGH STATION, SCARBOROUGH, NY, 10510-9227, US

(21) Appl. No.: 10/516,345

(22) PCT Filed: May 27, 2003
(86) PCT No.: PCT/IT03/00326

§ 371 Date: Nov. 30, 2004

(30) Foreign Application Priority Data
May 30, 2002 (IT) BS 2002 A 000051
Aug. 2, 2002 (IT) BS 2002 A 000069

(51) Int. Cl. B32B 27/32; B29C 47/06

(52) U.S. Cl. 428/35.2; 428/35.7; 264/173.16; 264/210.2; 156/209; 156/244.25

(57) ABSTRACT

The invention concerns a method of forming a film for the construction of bags for vacuum packing of products which comprises: depositing an additional resin film on the internal face of an initial film, running the initial film complete with the added film between a smooth feed roller and a shaping roller having a multiplicity of alternating peripheral impressions and ridges, and bringing the additional film in close contact with the shaping roller so as to have portions of additional resin flow into the impressions of the shaping roller to form the ridges defining the ducts. The invention also concerns the film realised with the method and the bags constructed using such film.

### FIELD OF INVENTION

This invention concerns in general bags used for vacuum packaging of products, and in particular concerns a method for forming multi-layer film for the construction of said bags, including the bags made using this film.

### STATE OF THE ART

For the packaging and vacuum preservation of foodstuffs, such as meat, sliced salami, cheeses, etc., bags made, starting from a film made up of two or more closely coupled layers or films are already well known. In fact bags for this use where each wall is made up of at least one gas-proof external layer or film and by an internal layer or film which is heat sealable and compatible with the product to be packed are well known.

In order to evacuate the air from the bag so as to form a vacuum at the moment the product is housed in the bag, the internal surfaces of at least one wall of the bag has a large number of ducts which facilitate aspiration and exit of the air from the bottom towards the mouth of the bag itself before it is sealed by welding.

In one of the well known ways of realisation, each bag has a network of ducts which criss-cross defined by embossing, that is deformation caused by pressure of the internal surface of at least one wall of the bag.

According to another way of realisation, on at least one of the internal surfaces of each bag there are bubbles or blisters which define a network of ducts to evacuate the air. In this construction, the bubbles or blisters are provided to receive an inert non-toxic gas to be released gradually towards the inside of the bag to conserve the packed product.

Both the embossed film and the film with bubbles, even when coupled with smooth film, do not cause any particular problems in usage with the abovementioned constructions of bags for the required use, in that the ducts which facilitate the evacuation of the air do not run in one direction only.

In still another way of realisation, the air outlet ducts on at least one internal face of each bag are defined by a series of filiform ribs or ridges running from the bottom to the mouth of the bag itself. The ribs or ridges defining the ducts can be either parallel, rectilinear or neither, or diverging in a V shape in the direction of the length of the film.

The filiform ridges, in particular if longitudinal and parallel, can be achieved by extrusion, that is deposited on the base multi-layer film. However, the longitudinal direction of the ridges and consequently the ducts, on the base film implies the use of a specific formation technique of the bags and the availability of particular complex and costly equipment. It is mandatory in fact for these bags to be formed by handling, using and sectioning the film lengthwise so that the ducts defined by the ribs or ridges extend from the bottom to the mouth of each bag, whereas there exist more usual, established and economic techniques and equipment which could be more profitably used, such as those used in making the bags starting from smooth, embossed film or film with bubble protuberances such as those mentioned above.

### OBJECTS AND SUMMERY OF THE INVENTION

Starting from these premises, one of the objectives of this invention is to propose a new, original method for making film for forming bags for vacuum packing, according to which no matter in which direction the ribs defining the air exit ducts are placed, whether parallel, criss-crossed, diverging, blister etc., they are achieved by the hot mechanical deformation of an additional film placed on the composite base film just after the extrusion of the latter or later on a previously prepared film.

Another objective of the invention is the realisation of a composite film grooved so that this film can be used in making bags without the need for particular equipment, but by simply taking advantage of the usual and more economic techniques and equipment, the same type used, as stated above, in the construction of bags starting from film which is either smooth, embossed or with blister protrusions.

Yet another objective of the invention is to supply a bag for vacuum packaging of foodstuffs made using film realised using the method of the invention.

These objectives and the advantages resulting from them are achieved using a method according to claim 1, and by a bag for vacuum packaging according to claim 8

### A BRIEF DESCRIPTION OF THE DRAWINGS

The invention will be illustrated more in detail in the continuation of this description made in reference to the enclosed, indicative and non-limiting drawings, in which:

FIG. 1 shows, schematically the equipment and the procedure for forming the ribbing or blisters on one surface of a film;

FIG. 2 shows a partial cross section of the film complete with protrusions;

FIG. 3 shows an example of a bag made starting from the film achieved using the procedure in claim 1;

FIG. 4 shows, other equipment, in schematic form, for a procedure for making film with ribbing diverging in a V shape;

FIG. 5 shows a procedure for making film with ducts running crosswise; and

FIG. 6 shows a procedure for making film with ducts which criss-cross.

### DETAILED DESCRIPTION OF THE INVENTION

In these drawings, 10 indicates a base film made up of, as is well known, at least two layers or films of a different plastic material, closely coupled by, for example, co-extrusion. The film 10 is usually made up of an external gas-proof layer 11 and an internal layer 12 made of a hot sealable thermoplastic material, compatible with the product to be packed.

By means of an extruder 13 an additional layer of film 14, either of the same resin or which is compatible with the film forming the same internal layer, is laminated on the surface of the internal layer 12, immediately after the base film has been extruded or in a later period using the same film.

The film is then made to pass between a guide roller 15, basically smooth, and a shaping roller 16. The external layer 11 of the film rests against the guide roller 15, whereas the added layer 14 is subjected to the direct action of the shaping roll 16.

According to another method shown in FIG. 1, recesses 17 have been shaped in the external surface of the shaping roller in a pre-set quantity, dimension, shape and pattern. The shaping roller, on contact with the added film 14 on the base film, causes it to deform under the heat which leads to the resin of the film itself upsetting into the recesses 17 of the shaping roller, forming solid ridges 18.

The result of this type of procedure is shown in FIG. 2, which is a cross-section of the initial film made up of external 11 and internal 12 layers, and the added film 14 which the ridges 18 protrude from defined by the isolated recesses 17 of the shaping roller 16.

The composite film produced in this way can then be used to make bags for vacuum packaging as shown for example in FIG. 3. In fact, the film complete with protrusions 18 can be coupled with a flat film, such as the dual layer starting film 10, welding three of the edges together and leaving one end open to accept the product to be packed.

The bag made in this way has the internal surface of at least one wall with solid protrusions 18, which prevent direct contact and adhesion of the internal surfaces of the two opposite walls and which define a network of ducts used to facilitate exit of the air when the bag is connected to an extractor to create a vacuum and to be sealed by welding when a product is packed to be preserved.

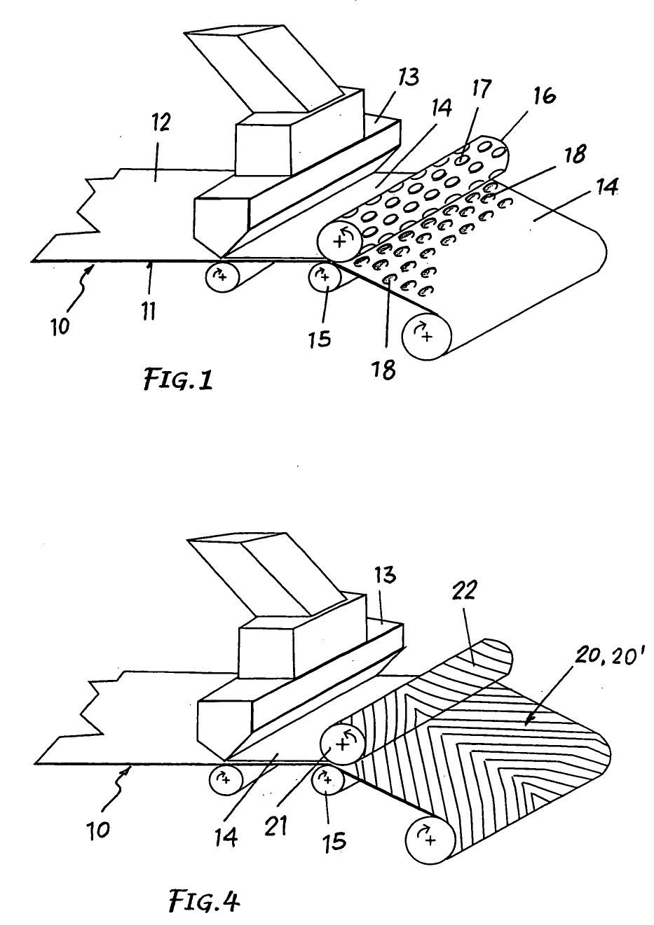

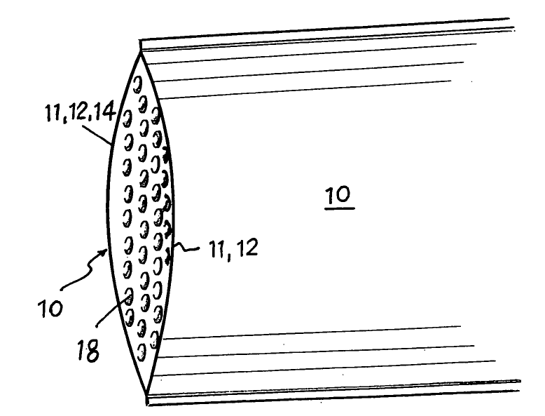

According to another procedure of the invention, on the internal surface of an initial film 10 an additional resin film 14 is deposited, by means of an extruder 13 as described above, such film being deformed to create a series of rectilinear, corrugated or zigzag ridges 20 and recesses 20′, having a fishbone pattern, that is, diverging in a V shape pattern lengthwise on the film starting from a middle point and extending towards the opposite sides. In order to form this pattern a roller 21 is used which has peripheral helical ridges 22 diverging from the middle point towards the opposite ends of the roller itself, as shown in FIG. 4, and destined to form a series of ridges 20 and recesses 20′ defining rectilinear or different shaped ducts which will extend from the bottom to the mouth of the bag that will be made.

The ducts formed on the internal face of the film can be connected crosswise to each other by shaping transversal recesses in the ridges that delimit them. In other words, these ridges will be discontinuous and to make them during the lamination process, protrusions will be provided at the required intervals in the grooves between the ridges 22 of the shaping roller so as to form the necessary recesses 20.

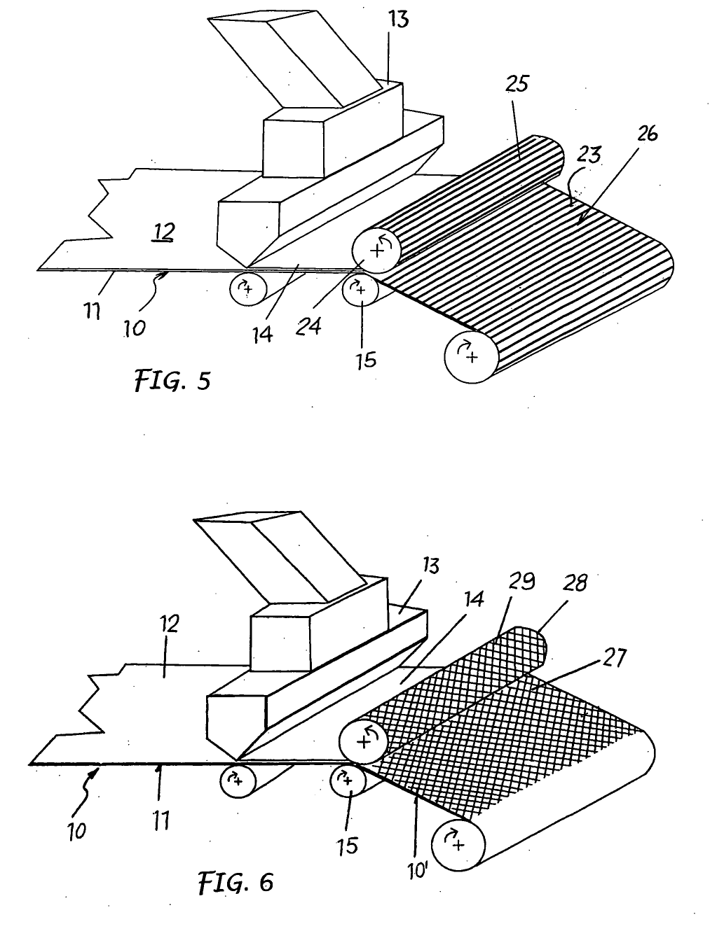

Using the method of the invention it is also possible to form a multilayer film with ducts 23 positioned crosswise to its length. Also in this case, an initial film 10 on which an additional resin film 14 has been deposited by an extruder 13, is passed between a smooth guide roller 15 and a shaping roller 24. As shown in FIG. 5, a preset number and size of peripheral grooves 25 have been cut in the external surface of the shaping roller 24, basically on the same axis as the roller itself. The grooves 25 can be parallel or non parallel, rectilinear, corrugated or any other shape and continuous or discontinuous. So, the shaping roller 24, on contact with the added film 14 on the initial film, causes it to deform under the heat which leads to the resin of the film itself upsetting into the peripheral grooves 25 forming ridges 26 which are basically filiform defining the ducts 23.

The film made in this way has therefore ducts oriented crosswise to its length and can be used to make bags for vacuum packing. The film, complete with ridges/ducts 26, 23 can in fact be used with and welded to another analogous film, or a flat film, such as the dual layer initial film 10, to form a tubular element which is then used and cut so as to form bags the depth of which is oriented in the direction of the width of film and where the ducts extend from the bottom to the mouth of each bag.

Using the method of the invention and with the use of a shaping roller 28 where grooves 29 have been provided in the peripheral surface which criss-cross as shown in FIG. 6 it is also possible to make multilayer film 10′ with ducts 27 running in two directions and which cross each other.

1. Method of forming a film for the construction of bags for vacuum packing of products starting from a film made up of at least one external layer made of a gas-proof plastic material and by an internal layer made of a thermoplastic material which can be hot welded, closely coupled, characterized by the steps of:
depositing, using an extruder, an additional resin film on the internal layer of the initial film, the additional resin being the same as or compatible with the thermoplastic material of said internal layer,
having the initial film complete with additional film to pass between a smooth feed roller and a shaping roller having a number of peripheral impressions, and
placing said additional film in close contact with said shaping roller so as to have portions of additional hot resin upset into the peripheral impressions of the shaping roller, forming corresponding ridges protruding from the internal surface of the composite film and defining a network of ducts.

2. Method of forming a film according to claim 1, wherein the additional resin film is deposited on the surface of the internal layer of the initial film immediately following extrusion of the latter or later on a previously prepared film.

3. Method of forming a film according to claim 1, wherein the shaping roller has isolated peripheral recesses to define the protrusions in the form of blisters with the added resin film.

4. Method of forming a film according to claim 1, wherein the shaping roller has a multiplicity of alternating peripheral grooves and helical ribs, either rectilinear or not, diverging in a V formation in the direction of the length of the film starting from a median point towards the opposite sides to define together with the additional resin film, ducts which extend obliquely to the length of the film, with the possibility of interrupting crosswise said grooves so as to place the resulting ducts in communication.

5. Method of forming a film according to claim 1, wherein the shaping roller has a multiplicity of peripheral grooves that extend in compliance with the axis of the roller itself to define together with the additional resin film an equivalent number of ridges with ducts oriented crosswise to the length of the film.

6. Method of forming a film according to claim 1, wherein the shaping roller has a multiplicity of peripheral crossing grooves to define with the additional resin film an equivalent number of ducts which cross each other.

7. A multi-layer plastic material film, for the forming of bags for vacuum packing of products, made according to the forming method in compliance with claim 1.

8. A bag for vacuum packing of products made using the composite film according to claim 7 and a smooth coupled film.

9. A bag for vacuum packing of products made using an initial composite film with fishbone patterned ducts and a second film similar to said initial composite film but differently oriented.

10. A bag for vacuum packing of products made using two films with differently shaped ducts.

11. Method of forming a film according to claim 2, wherein the shaping roller has isolated peripheral recesses to define the protrusions in the form of blisters with the added resin film.

12. Method of forming a film according to claim 2, wherein the shaping roller has a multiplicity of alternating peripheral grooves and helical ribs, either rectilinear or not, diverging in a V formation in the direction of the length of the film starting from a median point towards the opposite sides to define together with the additional resin film, ducts which extend obliquely to the length of the film, with the possibility of interrupting crosswise said grooves so as to place the resulting ducts in communication.

13. Method of forming a film according to claim 2, wherein the shaping roller has a multiplicity of peripheral grooves that extend in compliance with the axis of the roller itself to define together with the additional resin film an equivalent number of ridges with ducts oriented crosswise to the length of the film.

14. Method of forming a film according to claim 2, wherein the shaping roller has a multiplicity of peripheral crossing grooves to define with the additional resin film an equivalent number of ducts which cross each other.
